(19) United States
(12) Patent Application Publication
(10) Pub. No.: US 2006/0096792 A1
(43) Pub. Date: May 11, 2006

(54) Mobility device

(76) Inventor: Boris Usherovich, Staten Island, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/143,786

(22) Filed: Jun. 2, 2005

Related U.S. Application Data
(60) Provisional application No. 60/625,613, filed on Nov. 5, 2004.

(51) Int. Cl. B62M 7/14

(52) U.S. Cl. 180/11; 180/205

(57) ABSTRACT

A mobility device is provided for converting a manually powered wheel chair or stationary chair to a powered mobile chair. The mobility device includes a housing, a pair of independently and/or simultaneously operable reversible motors, and a pair of drive members. The drive members may be in the form of frictional contact members for driving the rear wheels of a wheel chair or drive wheels for supporting and driving a stationary chair. A control device can be provided to control operation of the drive motors, and thus, movement of the stationary or wheel chair. The mobility device may include one or more rechargeable batteries which may be supported internally or externally of the housing.

This application claims priority from U.S. Provisional Application Ser. No. 60/625,613, filed on Nov. 5, 2004.

### BACKGROUND

1. Technical Field

The present disclosure relates to a mobility device for use with an existing chair. More particularly, the present disclosure relates to a mobility device which can be attached to an existing wheel chair or stationary chair to convert the chair from a manually driven or stationary chair to a powered mobile chair.

2. Background of Related Art

The use of wheel chairs including both powered and manually driven wheelchairs has been well known for a great number of years. Wheel chairs have been used to effect the transport of the injured, sick, aged or some combination thereof. Typically, known manually operated wheel chairs include two large rear wheels which can be grasped by an occupant and rotated to advance the chair. Known powered wheel chairs include a fairly complex drive system for driving the wheels of the wheel chair in response to operation of a set of hand controls or the like. Known powered wheel chairs are substantially more costly than manually operated wheel chairs.

One problem associated with manually operated wheel chairs is that operation of the wheel chair is dependent on an occupant's strength. Since many wheel chair occupants do not have the strength to operate a manually operated wheel chair, they are left with only two options: 1) bear the great expense of purchasing a powered wheel chair; or 2) give up the freedom of mobility.

Accordingly, a continuing need exists in the art for an inexpensive device for effecting powered movement of a wheel chair or stationary chair.

### SUMMARY

In accordance with the present disclosure, a mobility device is provided which includes a housing, at least one drive motor supported within the housing, a pair of drive members which are operably connected to the drive motor, and a securement mechanism which is adapted to secure the mobility device to facilitate powered movement of the chair. In one embodiment, the at least one drive motor includes a pair of independently operable reversible motors. Each drive motor is connected to a respective drive member.

In a first embodiment, the securement mechanism is configured to secure the mobility device to a manually operated wheel chair such that each of the drive members is in frictional contact with a rear wheel of the wheel chair. The securement mechanism can be configured to releasably secure the mobility device to the wheel chair. in one embodiment, the securement mechanism includes at least one bracket which is movable, e.g., pivotal, to move the drive members from a position contacting the rear wheels of a wheel chair to a position spaced from the rear wheels of a wheel chair. The at least one bracket may include a pair of brackets and a lever can be provided to effect movement of the bracket assembly.

In one embodiment, a control device is provided for independently and/or simultaneously operating the drive members. The control device may be in the form of a toggle or joy stick although the use of other control devices is envisioned. As discussed above, the drive motors are reversible and are operable simultaneously. As such, the motors may be operated simultaneously in opposite directions to effect immediate 180° turning of a wheel chair. In another embodiment, the control device can be connected to the drive motors via a wireless transmission.

In one embodiment, the mobility device includes an occupancy sensor. The occupancy sensor may be positioned on the seat or seat back of the wheel chair and functions to prevent operation of the drive motors until an occupant is properly seated in the wheel chair.

In another embodiment of the presently disclosed mobility device, the securement mechanism includes at least one holder configured to receive and support a pair of legs of a stationary chair. The mobility device further includes one or more, e.g., two, leg supports for supporting the remaining legs of the chair. The drive members each include a drive wheel for supporting and driving the stationary chair. The at least one holder may comprise a support member having an elongated slot dimensioned to receive the rear legs of a stationary chair. Alternately, the at least one holder may include a pair of holders, each defining a cup for receiving a leg of a stationary chair.

In another embodiment of the presently disclosed mobility device, the securement mechanism includes clamps for securing the mobility device to the base frame of a roller chair and the drive members include drive wheels for supporting one side of the roller chair.

### DETAILED DESCRIPTION OF PREFERRED EMBODIMENTS

Preferred embodiments of the presently disclosed mobility device will now be described in detail with reference to the drawings, in which like reference numerals designate identical or corresponding elements in each of the several views.

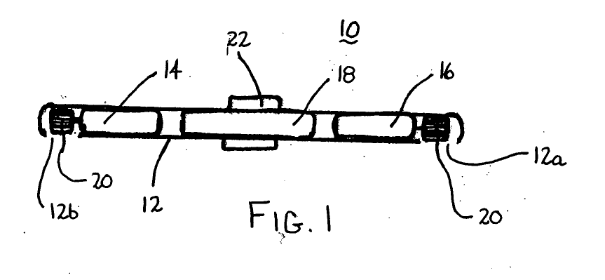

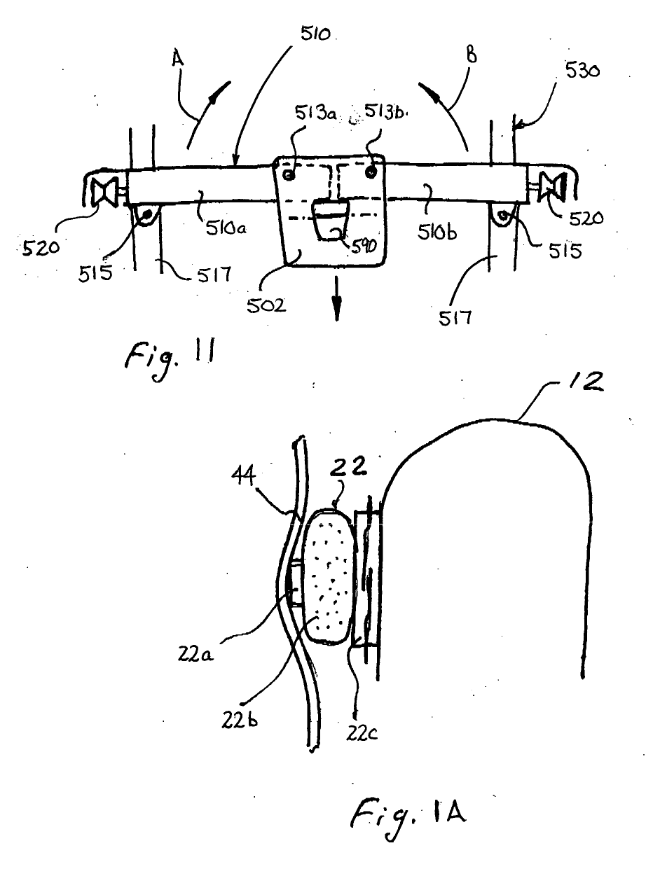

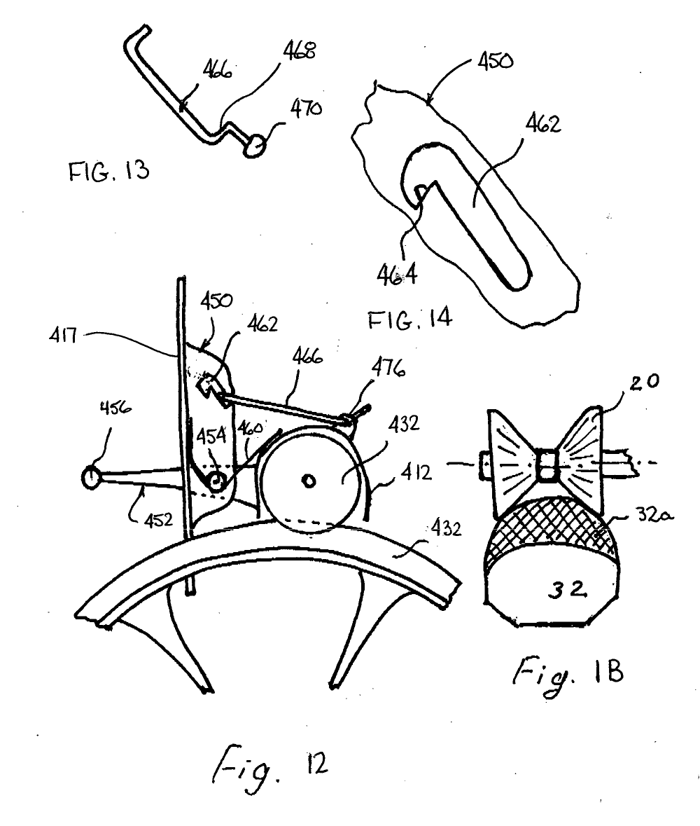

FIG. 1 illustrates one embodiment of the presently disclosed mobility device shown generally as 10. Mobility device 10 includes a housing 12 having a first opening 12a and a second opening 12b. Housing 12 is dimensioned to receive at least one, and preferably, a pair of drive motors 14 and 16. Housing 12 may be constructed from a metal or a plastic having the requisite strength requirement. Alternately, other materials of construction can be used to construct housing 12. In one preferred embodiment, a battery 18 is supported within housing 12 for powering drive motors 14 and 16. Preferably, motors 14 and 16 are reversible DC motors and battery 18 is a 12V rechargeable battery. Alternately, other known drive motors and power sources may be used to operate the mobility device. It is also envisioned that the battery can be supported externally of device 10 on a wheel chair.

As illustrated in FIG. 1, a drive member 20 is rotatably attached to each drive motor 14 and 16. Each drive member 20 preferably includes a circular body or cylinder having a rubber coating which is positioned adjacent a respective opening 12a, 12b in housing 12. Alternately, drive member 20 may be formed of a variety of materials or have a variety of configurations which facilitate engagement with or movement of the wheel of an existing wheelchair. For example, referring to FIG. 1B drive member 20 may include a pair of conical surfaces 20a and 20b which together define a valley or recess 20c for receiving rear wheels 32 of wheelchair 30. As illustrated, wheels 32 may include a roughened surface 32a for enhancing frictional contact between wheels 32 and drive members 20. Each drive member 20 is positioned to be movable into frictional engagement with the wheel of an existing wheelchair in the manner to be discussed herein to effect rotation of a wheelchair wheel.

In another preferred embodiment, a wheelchair occupancy sensor 22 is supported on housing 12 of mobility device 10. Occupancy sensor 22, when attached to a wheelchair, controls the supply of power to drive motors 14 and 16. More specifically, occupancy sensor 22 acts as a switch for delivering power to drive motors 14 and 16. The switch is normally in an off position and will only move to an on position when an occupant is safely seated in the wheel chair. In one embodiment, shown in FIG. 1A, occupancy sensor 22 includes a magnetic member 22a, a compressible member 22b, e.g., sponge, and a switch assembly 22c. Occupancy sensor 22 is supported on housing 12 of mobility device 10, adjacent backrest 44 of wheelchair 30. When an occupant is seated in wheelchair 30 against backrest 44, magnetic 22a is pushed against compressible member 22b and moves toward switch assembly 22c to actuate switch assembly 22c. It is envisioned that other occupancy sensor types may be used in conjunction with mobility device 10. Further, occupancy sensor 22 may be attached integrally to or be separate from mobility device 10 and can be positioned at multiple locations on wheelchair 30, e.g., seat, seat back, arm rest, etc.

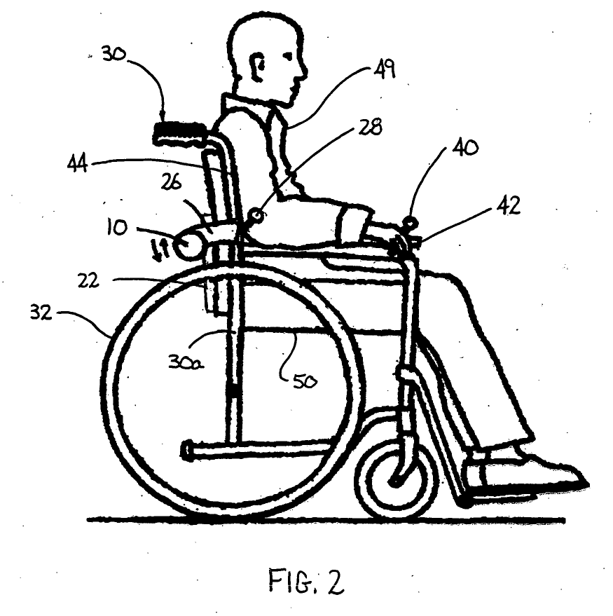

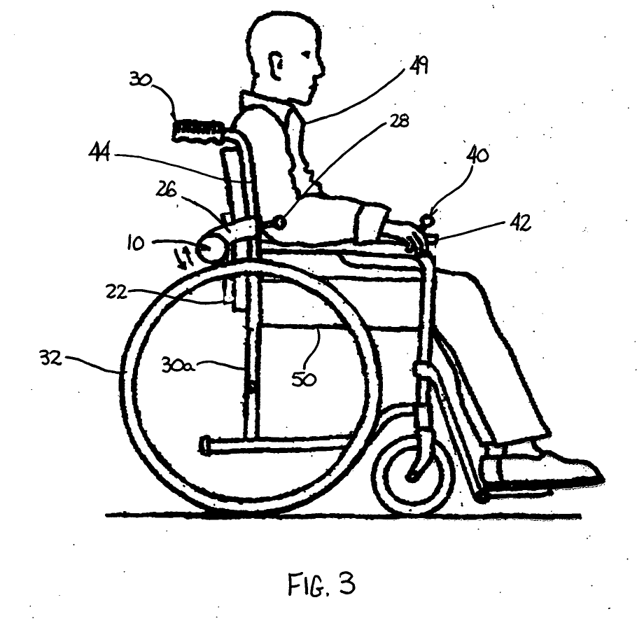

Referring to FIGS. 2 and 3, mobility device 10 is secured to an existing wheel chair using, for example, a pair of adjustable brackets 26. As illustrated in FIG. 2, in a first position, brackets 26 support mobility device 10 at a location in which drive members 20 (FIG. 1) are spaced from rear wheels 32 of an existing wheelchair 30. A lever 28 is supported on brackets 26 and is movable to pivot or move drive members 20 into frictional engagement with rear wheels 32 of wheelchair 30. Brackets 26 can be supported in a known manner to a frame 30a of wheelchair 30. Alternately, other securement mechanisms can be used to secure mobility device 10 to an existing wheel chair.

As illustrated in FIGS. 2 and 3, a joy stick or control device 40 is electrically connected to mobility device 10 via electrical wires or a wireless transmission. Control device 40 is operable in a known manner to independently or simultaneously control operation of drive motors 14 and 16 to effect movement of wheel chair 30 in any direction. In one embodiment, control device 40 is secured to an arm rest 42 of frame 30a of wheelchair 30 to provide easy access to a wheelchair occupant 49. Alternately, other known wheelchair or motor control devices may be used to operate mobility device 10, e.g., pedal operated controls, pneumatic controls, etc.

Occupancy sensor 22 is preferably supported adjacent a backrest 44 of wheelchair 30. As such, when an occupant sits in wheelchair 30, occupancy sensor 22 is moved from its normally off position to an on position to allow power to drive motors 14 and 16 in response to operation of control device 40. Alternately, occupancy sensor may be formed separately of mobility device 10 and positioned at other locations on wheelchair 30, e.g., seat 50.

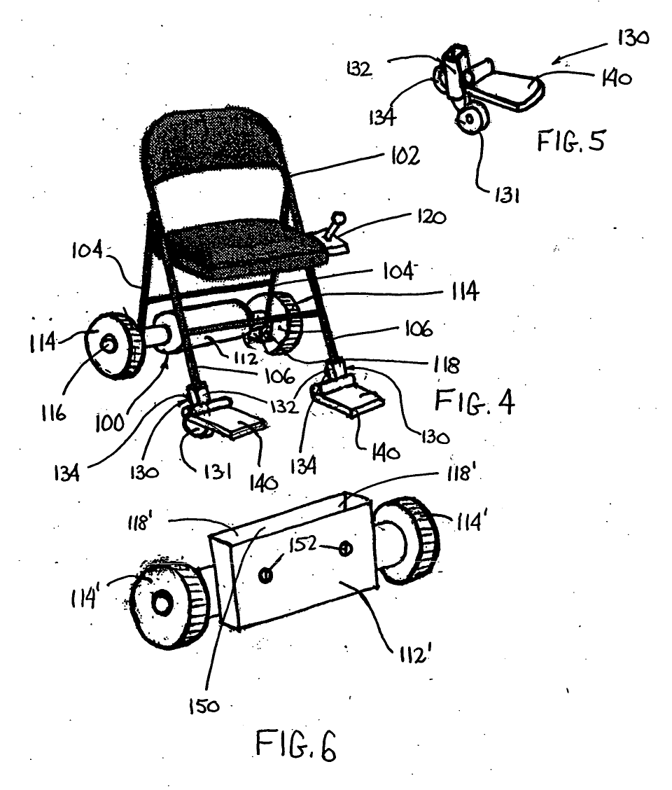

FIGS. 4 and 5 illustrate an alternate embodiment of the presently disclosed mobility device shown generally as 100 attached to a stationary chair 102. Mobility device 100 as shown in FIG. 4 is suitable for use with a stationary chair 102 having two rear legs 104 and two forward legs 106 and includes a housing 112, a pair of drive wheels 114 rotatably supported by an axle 116 and a pair of holders 118 (only one is shown) for receiving the rear legs 104 of chair 102. Holders 118 define cups for slidably receiving rear legs 104 of chair 102. Housing 112, as discussed above with respect to mobility device 10, includes first and second reversible drive motors (not shown) for independently or simultaneously driving one or both drive wheels 114. A control device 120, e.g., a joystick, is electrically or wirelessly connected to mobility device 100 to selectively control operation of the first and second drive motors and thus, drive wheels 114. An occupancy sensor may also be provided to prevent operation of mobility device 100 until an occupant is safely seated on chair 102.

A pair of front leg supports or shoes 130 each include a wheel 131, e.g., a caster, and leg receptor 132. Each leg receptor 132 is configured to receive the front leg of stationary chair 102. A lock or set screw 134 can be provided on each shoe 130 to prevent removal of shoe 130 from each leg 106. In a preferred embodiment, a foot rest 140 is pivotally secured to each of shoes 130 to provide a foot rest for a chair occupant.

In use, the rear legs 104 of a stationary chair 102 are positioned in holders 118 of mobility device 100 and shoes 130 are secured to each of front legs 106 of chair 102 using locking device 134, e.g., a set screw. Control device 120 can now be operated to selectively actuate one or both of the first and second drive motors to drive one or both of drive wheels 114 to selectively effect movement of stationary chair 102. In one embodiment, a clip or bracket (not shown) is provided on control device 120 to secure control device 120 to stationary chair 102.

In an alternate embodiment shown in FIG. 6, holders 118′ are formed integrally with housing 112 as an elongated pocket 150. Screws 152 are provided for securing rear legs 104 of stationary chair 102 within pocket 150. It is noted that in each of the embodiments disclosed above, holders 118, pocket 150 and also shoes 130, the chair legs are elevated only about one-half of an inch off the support surface. Alternately, other elevations may be provided where desired.

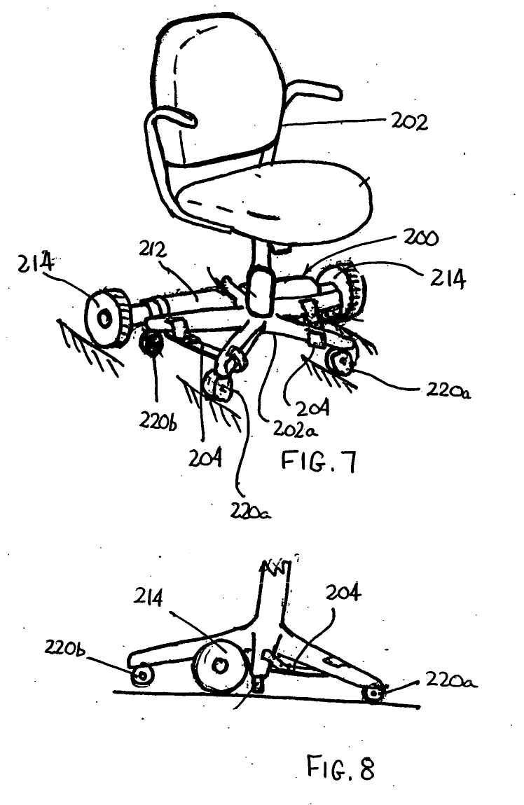

FIGS. 7 and 8 illustrate another embodiment of the presently disclosed mobility device 200 configured to be secured to any office type chair 202. As illustrated, mobility device 200 includes housing 212 and a bracket assembly 204 including a plurality of clamps for securing mobility device 200 to base frame 202a of chair 202. Mobility device 200 includes a pair of drive wheels 214 which support one side of chair 202 when mobility device 200 is secured to the chair. The other side of chair 202 is supported by wheels 220a of chair 202. Chair wheels 220b are elevated by drive wheels 214, preferably, about ⅛ to ½ an inch. Mobility device 200 operates in substantially the same manner as device 100 and will not be discussed in further detail herein.

FIGS. 9 and 10 illustrate a mounting assembly, shown generally as 300, for releasably securing mobility device 10 (shown schematically in FIG. 10) to the frame of a manually operated wheelchair 30. The mounting assembly includes a mounting bracket 302, a coupling device 304, and a support member 306 (FIG. 10). Mounting bracket 302 includes a body 310 having holes 312 dimensioned to receive screws (not shown) for securing bracket 302 to a wheel chair 30. Mounting bracket 302 also includes an extension 314 having a pair of spaced hooks 316. It is envisioned that hooks 316 or the like may be formed integrally with the frame of wheel chair 30.

Coupling device 304 includes a substantially U-shaped body 320 which defines a pair of spaced openings 322 dimensioned to receive hooks 316 of mounting bracket 302. When respective hooks 316 are positioned within openings 322, coupling device 304 is supported on mounting bracket 302. A base portion 324 of body 320 includes openings 326 which are dimensioned to receive screws 328 (FIG. 10) for securing coupling device 304 to support member 306.

A locking lever 330 is pivotally supported on an upper surface of coupling device 304. Lever 330 is pivotal about a pivot member 331 into engagement with upper hook 316 of mounting bracket 302 to prevent disengagement of coupling device 304 from mounting bracket 302. A biasing member 332 is positioned to urge lever 330 to the engaged or locking position. A finger loop 334 is provided to facilitate movement of lever 330, against the bias of member 332, to a disengaged position to allow removal of coupling device 304 from mounting bracket 302. A stop member 370 prevents over extension of biasing member 332 Support member 306 is pivotally secured to a flange 342 mobility device (FIG. 10) about a pivot member 340. Flange 342 can be fixedly secured to or integrally formed with mobility device 10. As discussed above, support member 306 is secured to coupling device 304. Mobility device 10 is pivotal about pivot member 340 into and out of engagement with wheel 32 of wheel chair 30. Although not illustrated, a locking member is provided to maintain mobility device 10 in its engaged and unengaged positions in relation to wheel 32.

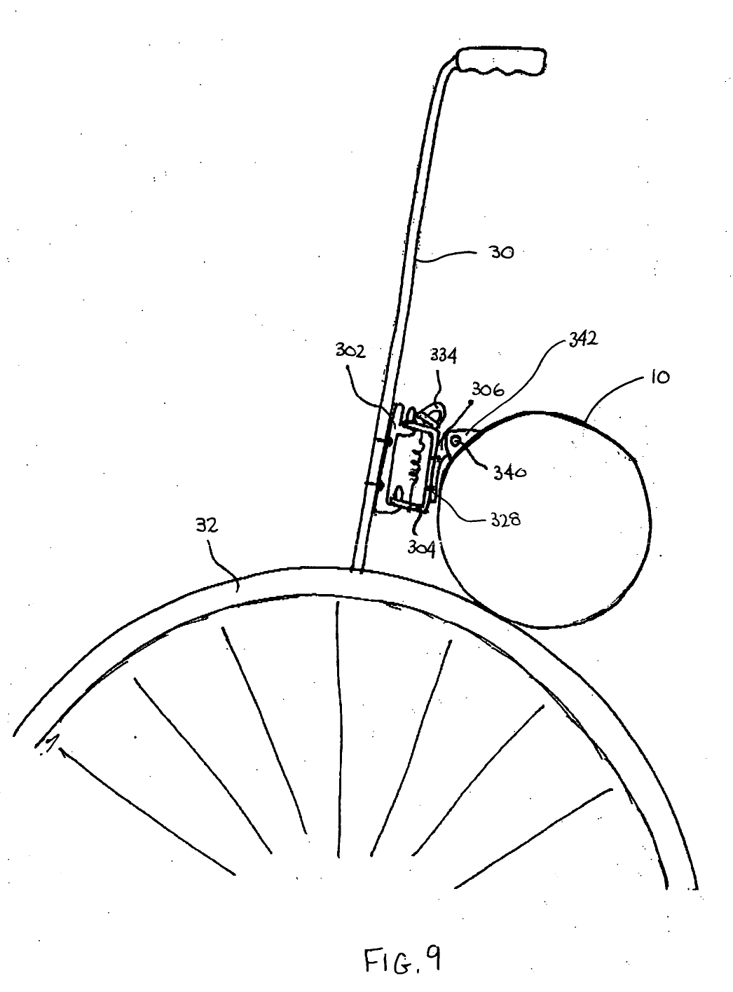

FIG. 11 illustrates another embodiment of the presently disclosed mobility device shown generally as 510. Mobility device 510 is similar in construction to mobility device 10 but is constructed for attachment to a frame 517 of collapsible wheelchair 530. As such, mobility device 510 includes a central support member or plate 502, a pivotal first portion 510a and a pivotal second portion 510b. Pivotal first portion 510a is pivotally supported in the direction indicated by arrow “A” on support plate 502 about a pivot member 513a and pivotal second portion 510b is pivotally supported in the direction indicated by arrow “B” on support plate 502 about a pivot member 513b. A latch 590, as known in the art, is provided to hold portions 510a and 510b in a horizontal locked position. When depressed, latch 590 releases portions 510a and 510b for pivotal rotation in the direction of arrows A and B in FIG. 11. Pins, screws or the like 515 are provided to pivotally secure each of first and second portions 510a and 510b to the frame of wheelchair 530 at a position to locate drive members 520 in frictional contact with the rear wheels of a wheelchair. It is envisioned that mobility device 510 may include any or all of the features described above with respect to mobility device 10, e.g., occupancy sensor.

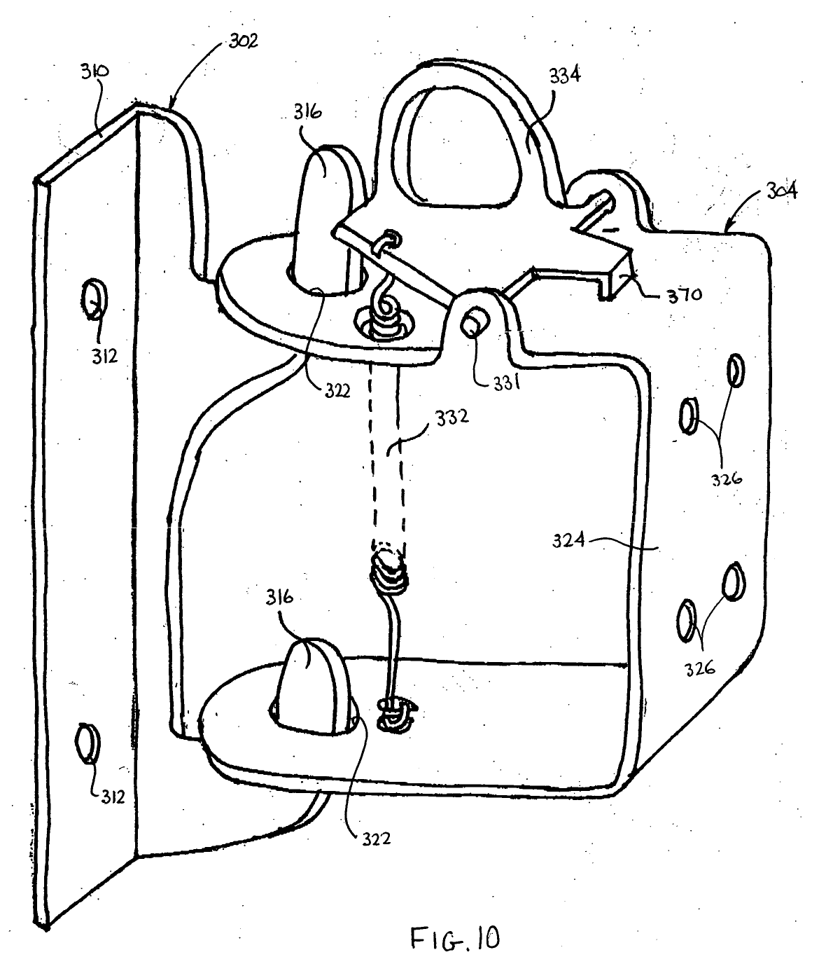

FIGS. 12-14 illustrate another embodiment of the presently disclosed bracket assembly 404 for securing mobility device 10 to a wheelchair 430. Bracket assembly 404 includes a pair of support brackets 450 and a pair of pivotal support links 452 (only one of each is shown). Each support bracket secured to a frame 417 of a wheelchair by one or more pivot members. Each support link 452 is pivotally secured to a respective support bracket 450 about a pivot member 454. Mobility device 10 is supported on one end of support links 452. The other end of support links 452 include a grip member 456. Grip member 456 is accessible to facilitate pivotable movement of support links 452 and mobility device 10 about pivot member 454 to effect movement of mobility device 10 from a first position engaged with a wheel 432 of a wheelchair to a second position disengaged and spaced from wheel 432. A biasing member 460, e.g., a spring can be provided to urge mobility device 10 towards the engaged position (FIG. 12).

In one embodiment, support bracket 450 includes a stepped cutout 462 defining a retainer shoulder 464 (FIG. 14). A link 466 having a locking surface 468 extends through cutout 462. One end of link 466 includes a gripping member, e.g., a knob 470, and the other end of link 466 is pivotally secured to a flange 476 positioned on housing 12 of mobility device 10. When mobility device 10 is moved from its engaged position to its disengaged position, link 466 moves along cutout 462 such that locking surface 468 is positioned adjacent shoulder 464. In this position, link 466 is pivotable downwardly, as viewed in FIG. 12, to move surface 468 behind shoulder 464 to lock mobility device 10 in its disengaged position against the bias of spring 460. By doing this, the wheelchair can be manually powered. When it is again desired to drive the wheelchair with mobility device 10, link 466 can be pivoted upwardly to allow spring 460 to move device 10 into engagement with wheel 432 of a wheelchair.

It will be understood that various modifications may be made to the embodiments disclosed herein. For example, therefore, the above description should not be construed as limiting, but merely as exemplifications of preferred embodiments. Those skilled in the art will envision other modifications within the scope and spirit of the claims appended hereto.

What is claimed:

1. A mobility device comprising:
a housing;
at least one drive motor supported within the housing;
a pair of drive members operably connected to the at least one drive motor; and
a securement mechanism adapted to secure the mobility device to a chair to facilitate powered movement of the chair.

2. A mobility device according to claim 1, wherein the at least one drive motor includes a pair of drive motors.

3. A mobility device according to claim 2, wherein each of the drive motors is independently operable and reversible and is operably connected to a respective one of the drive members.

4. A mobility device according to claim 3, wherein the securement mechanism is configured to secure the mobility device to a manually operated wheel chair such that each of the drive members is in frictional contact with a rear wheel of the wheel chair.

5. A mobility device according to claim 4, wherein the securement mechanism is configured to releasably secure the mobility device to a wheel chair.

6. A mobility device according to claim 4, wherein the securement mechanism includes at least one bracket.

7. A mobility device according to claim 6, wherein the at least one bracket is movable from a first position to a second position to move the drive members from a position contacting the rear wheels of a wheel chair to a position spaced from the rear wheels of a wheel chair.

8. A mobility device according to claim 7, wherein the at least one bracket includes a pair of brackets.

9. A mobility device according to claim 3, further including a control device for independently and/or simultaneously operating the drive motors.

10. A mobility device according to claim 9, wherein the control device includes a joy stick.

11. A mobility device according to claim 10, wherein the control device is operably connected to the drive motor via a wireless transmission.

12. A mobility device according to claim 9, further including an occupancy sensor, the occupancy sensor preventing operation of the drive motors until an occupant is seated on a wheel chair.

13. A mobility device according to claim 3, wherein the securement mechanism includes at least one holder configured to receive a pair of legs of a stationary chair, the mobility device further including a pair of leg supports, each leg support being adapted to support another leg of a stationary chair and including a wheel, and wherein the drive members each include a drive wheel.

14. A mobility device according to claim 13, wherein the at least one holder includes an elongated pocket for receiving the rear legs of a stationary chair.

15. A mobility device according to claim 13, wherein the at least one holder includes a pair of holders, each holder defining a cup configured to receive the leg of a stationary chair.

16. A mobility device according to claim 3, wherein the securement mechanism includes clamps for securing the mobility device to a base frame of a chair and the drive members include drive wheels.

17. A mobility device according to claim 1, further including at least one battery for supplying power to the at least one drive motor.

18. A mobility device according to claim 17, wherein the battery is rechargeable.

19. A mobility device according to claim 1, wherein the securement mechanism includes a mounting bracket and a coupling device, the mounting bracket being adapted to be secured to a wheel chair and the coupling device supporting the housing of the mobility device.

20. A mobility device according to claim 19, wherein the coupling device is releasably coupled to the mounting bracket.

21. A mobility device according to claim 1, wherein the housing includes a first portion pivotally secured to a support member and a second portion pivotally secured to the support member at a location spaced from the first portion.

22. A mobility device according to claim 21, wherein each of the first and second housing portions supports one of the at least one drive motors.

23. A mobility device according to claim 22, wherein each of the first and second housing portions supports a rechargeable battery.
